(19) United States
(12) Patent Application Publication
(10) Pub. No.: US 2011/0276341 A1
(43) Pub. Date: Nov. 10, 2011

(54) SYSTEM AND METHOD FOR AUTOMATIC DRUG PRESCRIPTION

(76) Inventor: Raghu M. Ramprasad, Bangalore (IN)

(21) Appl. No.: 13/099,398

(22) Filed: May 3, 2011

(30) Foreign Application Priority Data
May 7, 2010 (IN) 1277/CHE/2010

(51) Int. Cl. G06Q 50/00

(52) U.S. Cl. 705/2

(57) ABSTRACT

In one embodiment, a method of automatic drug prescription is provided. The method comprises steps of receiving a query at a central server system regarding a patient, the query concerning the type of drug and dosage level to be administered to the patient, obtaining patient data from at least one medical information system coupled to the central server system and processing the patient data to determine a set of drug and dosage level that can be administered to the patient.

### FIELD OF INVENTION

The invention generally relates to an integrated information system and more particularly to an integrated information system capable of analyzing patient data and recommending drugs based on the analysis.

### BACKGROUND OF THE INVENTION

Current systems for drug prescription are often time consuming, requiring the direct input of a healthcare professional. A user such as a doctor interested in prescribing drugs to a patient based on his condition would want to retrieve information about the laboratory reports, physiological parameters and patient allergies. The information so desired is to be gathered from one or more medical information systems located in different departments of a medical facility. For this, the doctor has to manually make arrangements for receiving the information from each of the medical information systems located within the medical facility. The process of gathering information may be time consuming, Subsequently, based upon the information received the doctor has to decide the kind of drug and dosage level that can be prescribed and administered to the patient.

One limitation associated with this process is, risk of being erroneous as the process involves human intervention. The risk can prove to be fatal if an allergic drug is inadvertently administered to the patient.

As an example, patients undergoing surgery, who have some renal dysfunction, pose a challenge to the anesthesiologists. The drugs delivered by the anesthetic devices have a profound effect on the renal function. Therefore, inappropriate drug and dosage level can be fatal to the patient.

Hence there exists a need for a system that can automatically provide the user with a set of feasible drugs that can be administered to the patient based on the patient condition.

### BRIEF DESCRIPTION OF THE INVENTION

The above-mentioned shortcomings, disadvantages and problems are addressed herein which will be understood by reading and understanding the following specification.

In one embodiment, a method of automatic drug prescription is provided. The method comprises steps of receiving a query at a central server system regarding a patient, the query concerning the type of drug and dosage level to be administered to the patient, obtaining patient data from at least one medical information system coupled to the central server system and processing the patient data to determine a set of drug and dosage level that can be administered to the patient.

In another embodiment, an automatic drug prescription device is provided. The automatic drug prescription device comprises a central server system configured to receive a query regarding the type of drug and dosage level to be administered to a patient, at least one medical information system coupled to the central server system and configured to provide patient data concerning the patient and wherein the central server system is configured to obtain patient data from the at least one medical information system and process the patient data to determine a set of drug and dosage level that can be administered to the patient.

In yet another embodiment, a computer-readable medium having computer-executable instructions for automatic drug delivery is provided. The computer-executable instructions comprise code for receiving a query at a central server system regarding a patient, the query concerning the type of drug and dosage level to be administered to the patient, code for obtaining patient data from at least one medical information system coupled to the central server system and code for processing the patient data to determine a set of drug and dosage level that can be administered to the patient

Systems and methods of varying scope are described herein. In addition to the aspects and advantages described in this summary, further aspects and advantages will become apparent by reference to the drawings and with reference to the detailed description that follows.

### BRIEF DESCRIPTION OF THE DRAWINGS

FIG. 1 shows a block diagram of an automatic drug prescription device described in an embodiment;

FIG. 2 shows a block diagram of a central server system as described in one embodiment;

FIG. 3 shows a flow diagram depicting automatic drug prescription method performed by the automatic drug prescription device;

FIG. 4 shows a flow diagram depicting the step of obtaining patient data from a medical information system;

FIG. 5 shows a flow diagram depicting the step of receiving a query as described in another embodiment; and

FIG. 6 shows a flow diagram depicting the step of coupling a drug source unit as described in one embodiment.

### DETAILED DESCRIPTION OF THE INVENTION

In the following detailed description, reference is made to the accompanying drawings that form a part hereof, and in which is shown by way of illustration, specific embodiments, which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

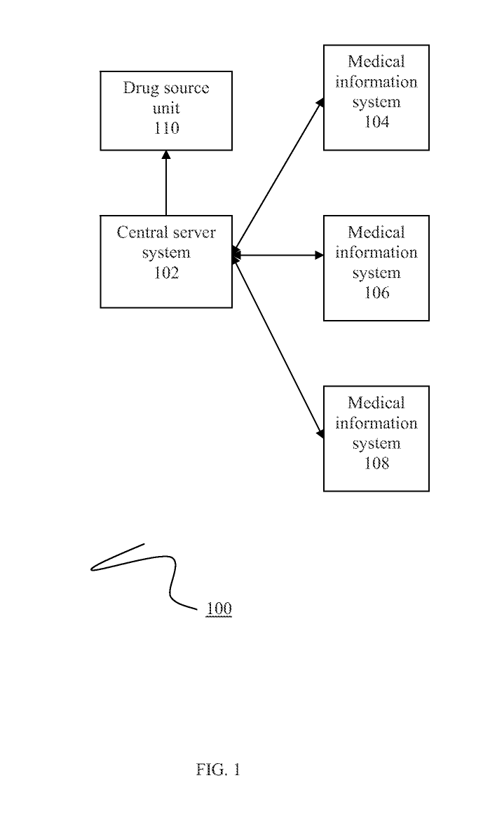

In one embodiment, as shown in FIG. 1, an automatic drug prescription device 100 is provided. The automatic drug prescription device 100 can be installed in a medical facility such as a hospital or clinic for performing an integrated central management of patient data.

The automatic drug prescription device 100 comprises a central server system 102 configured to receive a query regarding the type of drug and dosage level that is to be administered to a patient. The query comprises a patient identification data. The patient identification data comprises at least one of a patient name and a patient identification number.

The automatic drug prescription device 100 further comprises at least one medical information system 104, 106 and 108 coupled to the central server system 102. The at least one medical information system 104, 106 and 108 is configured to provide the patient data concerning the patient. Further, the central server system 102 is configured to process the patient data obtained from the at least one medical information system 104, 106 and 108 to determine a set of drug and dosage level that can be administered to the patient.

In one embodiment, the patient data includes general information concerning the patient such as identity, age, height, weight, sex, race, family and genetic medical data, medical history, physical handicaps, known medical conditions, known medical allergies, and current ailment conditions such as symptoms, duration, physician observations and other EMR records. The patient data further includes radiology information, laboratory information, clinical information concerning the patient and patient's pre-operative records. More specifically, the patient data comprises pathology reports, physiological data monitored by patient monitors, renal activity measurement including information on urine content and urine output, measured foreign gases in the inhaled or exhaled breath by the patient and information from drug database.

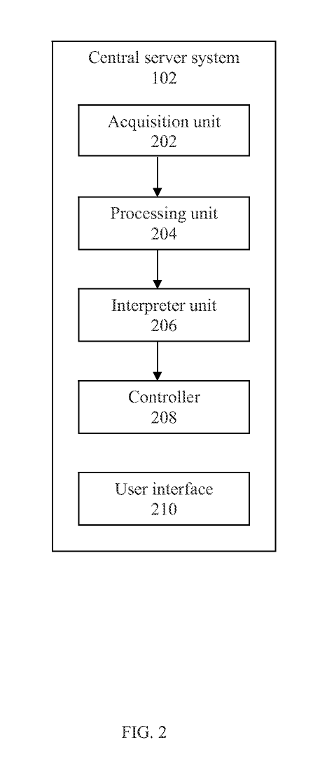

A block diagram of the central server system 102 is shown in FIG. 2. Accordingly, the central server system 102 comprises an acquisition unit 202 configured for collecting the patient data from one or more medical information systems 104, 106 and 108 coupled to the central server system 102 and located within the hospital network. Furthermore, the one or more medical information systems 104, 106 and 108 may be remotely located. These remotely located medical information systems 104, 106 and 108 may transmit the patient data to the central server system 102 via wired or wireless communication systems.

The central server system 102 may further comprise a processing unit 204 that receives and processes the patient data received from the medical information systems 104, 106 and 108.

Once the patient data is processed it may be analyzed or interpreted based on the patient condition by an interpreter unit 206 coupled to the processing unit 204. The analysis may be used in providing a set of prescriptions to the patient.

One or more rules may be applied to interpret the patient data based on the patient condition. A rule database supplies the rules to be used for the interpretation purpose. The rule database may be stored in the interpreter unit 206. The rule database may comprise a variety of logical rules that use patient data/information as a parameter. The results of the application of the rules can be stored in a patient history database so that a record of the automated patient prescription is maintained.

The central server system 102 further comprises a user interface (not shown) whereby the user may input commands to the central server system 102 and also receive information via an electronic display unit. The input unit comprises a keypad, keyboard, touch pad, light pen, laser pen, microphone or other device by which the user may enter the patient data, pre-set drug dosages and/or information requests such as requests for the patient data concerning the patient into the central server system 102. Alternatively, input may be received via bar code readers, external keypads, or even from an electronic source. Those skilled in the art will recognize several available means to communicate commands to the central server system 102.

The electronic display unit is configured for communicating to the user the type of drug and dosage level recommended for the patient, as determined by the central server system 102. The electronic display unit comprises a video or a computer monitor, a Liquid Crystal Display (LCD) display, a cathode ray tube display, a dot-matrix display, a touch screen display, a laser activated display or any other display providing a convenient display of the prescription data.

The medical information system 104, 106 and 108 is one of a laboratory information system (LIS), a clinical information system (CIS), a radiology information system (RIS), a picture archival and communication system (PACS), a gas analyzer, an anesthetic device, a urine output interpreter unit, a pulse oximeter, a capnometer, a blood pressure monitor, an EKG, an FEG, a patient monitor, a drug database unit and a renal blood flow monitor. Skilled artisans shall however appreciate that the description of the medical information system 104, 106 and 108 is not restricted to the examples provided herein and includes all such devices, which are used in the medical field for diagnosis and monitoring.

In one embodiment, each of the medical information systems 104, 106 and 108 is capable of communicating with the central server system 102 by way of a wire-line Local Area Network (LAN). Each of these medical information systems 104, 106 and 108 can be coupled to the central server system 102 by the same or different communication interfaces. In one specific embodiment, the central server system 102 communicates with the medical information system 104 such as PACS using the digital imaging and communication in medicine (DICOM) standard and with other medical information systems 104, 106 and 108 such as LIS, RIS and CIS using the HL7 standard.

In one embodiment, the medical information system 104 may include an electronic medical record database. The electronic medical record database may hold patient pre-operative medical records. The patient undergoes a set of medical tests to explore the factors affecting drug dosage amounts (such as age, weight, height and gender), including factors indicative of illness or high sensitivity to drugs, allergies and settings for that patient. These allergic gases/agents shall not be given as drugs for the patients. These allergic components are updated into the patient medical records.

In another embodiment, the medical information system 104 may include a drug database that includes information concerning prior prescriptions, allergy information, drug interaction information, drug treatment information and overdose information. The drug database can also include inventory information concerning a list of drugs that are available within the medical facility at any given point of time and a mapping of each drug versus one or more ailments that can be treated using the drug.

In yet another embodiment, the medical information system 104 may include one or more known patient physiological condition monitors such as pulse oximeters, capnometers, other ventilatory monitors, non-invasive blood pressure monitors, EKG, EEG and others, that are electronically coupled, through suitable A-D converters where appropriate, to the processing unit 204, described above. Each of these physiological parameters provides a clinician with a useful tool for determining the condition of a specific aspect of a patient's health.

Patient health monitors generate electronic feedback signals representing actual patient physiological data, which are converted to electronic signals and then provided to the processing unit 204. The processing unit 204 e.g., through appropriate software and/or logic, compares the received electronic patient feedback signals with a safety data set stored in a memory device (not shown).

The memory unit (not shown) comprises one or more memory types, such as RAM, ROM, local memory such as a cache memory and semiconductor memories, such as Electrically Erasable Programmable Read Only Memory (EEPROM). Further, the memory unit (not shown) is configured to store the patient data procured by the acquisition unit 202 from multiple medical information systems 104, 106 and 108.

The stored safety data set contains at least one set of data parameters representing safe and undesirable patient physiological conditions. Based on the comparison of the actual monitored patient physiological data with the safety data set, the processing unit 204 determines the drugs to be prescribed to the patient.

In an additional embodiment, at least one medical information system 104 is capable of receiving a query from a user concerning the drug and dosage level to be administered to the patient. The query thus received can be sent to the central server system 102. Subsequently, the central server system 102 may acquire the patient data corresponding to the patient from the one or more medical information systems 104, 106 and 108 including the medical information system 104 that has forwarded the query to the central server system 102. Subsequent to fetching the required information, the central server system 102 processes the patient data based on patient condition and determines the type of drug and dosage level that needs to be administered to the patient.

The drug and dosage level so determined can be displayed in the central server system 102 or can be sent to the medical information system 104 that had forwarded the query to the central server system 102. The medical information system 104 can subsequently display the information in a display device coupled to the medical information system 104. Based on these predictive results the user may take decision on the kind of drug that can be administered to the patient.

Further, the analysis of the patient's current condition may be utilized as an input for the drug dosage prescription and delivery. For this purpose, as shown in FIG. 1, the automatic drug prescription device 100 further comprises a drug source unit 110 coupled to the central server system 102. The drug source unit 110 is configured to deliver the set of drug and dosage level, to the patient, as determined by the central server system 102.

The central server system 102 may further comprise a controller 208 (shown in FIG. 2) coupled to the drug source unit 110. The controller 208 may be coupled to the interpreter unit 206. Further, the controller 208 may be external to the interpreter unit 206 or incorporated within the interpreter unit 206. The drug source units are well known in the art and are capable of volumetric control of one or more IV tubes thereby controlling the delivery rate of one or more drugs. Accordingly, the drug source unit 110 is controllable from the controller 208, i.e., the rate of drug delivery is controlled by the controller 208. Once the interpreter unit 206 has determined the drug and dosage level that is to be administered to the patient, the information is passed on to the controller 208. The controller 208 uses the information received from the interpreter unit 206 to adjust the rate of drug delivery from the drug source unit 110. However, the drug delivery rate may be adjusted by data received from the controller 208 or by a user input.

In an exemplary embodiment, the interpreter unit 206 may recommend delivery of insulin therapeutic fluid based on the concentration of glucose present in a blood sample of the patient. The interpreter unit 206 may further, based on measurements from the blood sample from the patient, compute a recommended optimal dosage. In this embodiment a patient, possibly diabetic, is connected to the drug source unit 110. The dosage of delivery of insulin therapeutic fluid is based on the measured concentration of the glucose present in the blood sample of the patient and a target glucose level that is input by an operator. The drug source unit 110 is configured to infuse the insulin therapeutic fluid based on the dosage recommended/calculated to achieve the target glucose level.

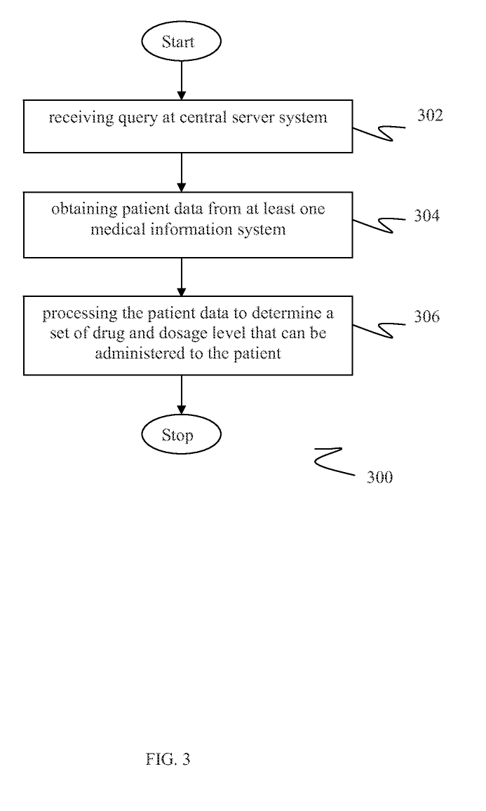

Further, a method in accordance with an embodiment of the invention is illustrated schematically in the flowchart of FIG. 3. The method 300 of automatic drug prescription comprises steps of receiving a query at the central server system 102 regarding a patient, at step 302, the query concerning the type of drug and dosage level to be administered to the patient, obtaining patient data from at least one medical information system 104, 106 and 108 coupled to the central server system 102, at step 304, and processing the patient data to determine a set of drug and dosage level that can be administered to the patient, at step 306.

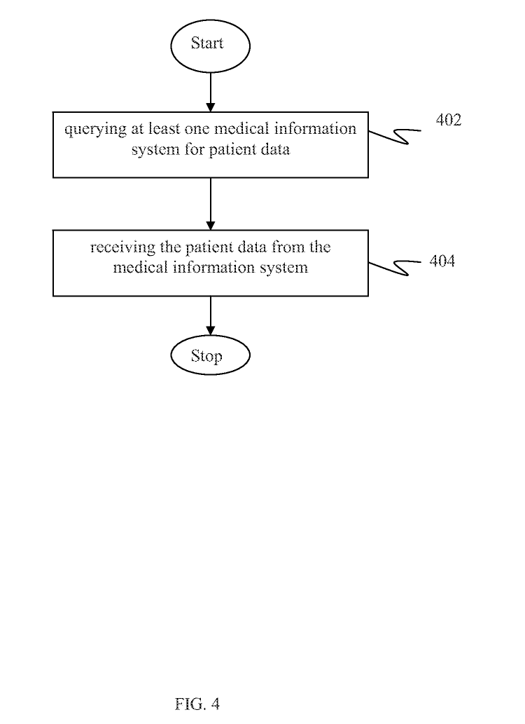

The step 304 of obtaining patient data is further explained in conjunction with FIG. 4. Step 304 comprises querying the at least one medical information system 104, 106 and 108 for the patient data concerning the patient, at step 402, and receiving the patient data from the at least one medical information system 104, 106 and 108, at step 404.

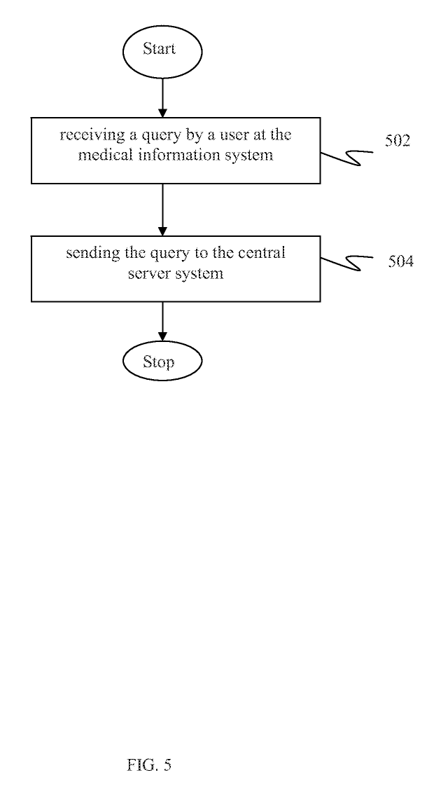

In one embodiment, as shown in FIG. 5, the method 300 further comprises receiving a query by a user at the at least one medical information system 104, regarding the type of drug and dosage level to be administered to the patient, at step 502 and sending the query to the central server system 102, at step 504.

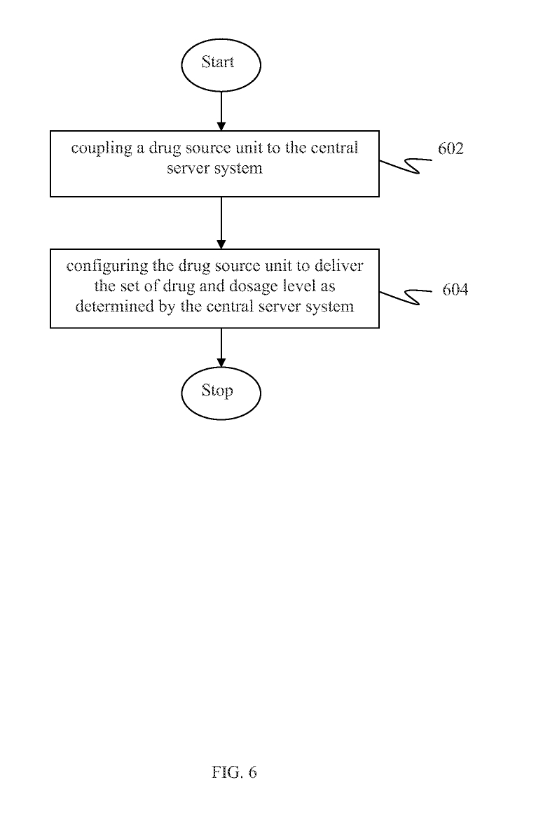

The invention electronically integrates automatic prescription and delivery of one or more drugs to the patient with the automated analysis of patient data. Accordingly, in another embodiment, as shown in FIG. 6, the method 300 further comprises coupling the drug source unit 110 to the central server system 102, at step 602 and configuring the drug source unit 110 to deliver the set of drug and dosage level to the patient as determined by the central server system 102, at step 604.

As described in various embodiments, the processing unit 204 electronically manages the operation of the central server system 102 by means of conservative, decision-making software that integrates and correlates patient data received from several medical information systems 104, 106 and 108 with drug delivery. Accordingly, the invention also relates to a computer program comprising a computer program code for executing the method described above, as well as to a computer-readable medium having computer-executable instructions recorded thereon.

The computer-executable instructions comprise code for receiving a query at the central server system 102 regarding a patient, the query concerning the type of drug and dosage level to be administered to the patient, code for obtaining patient data from at least one medical information system 104, 106 and 108 coupled to the central server system 102 and code for processing the patient data to determine a set of drug and dosage level that can be administered to the patient.

The code for obtaining patient data comprises code for querying the at least one medical information system 104, 106 and 108 for patient data concerning the patient and code for receiving the patient data from the at least one medical information system 104, 106 and 108.

In one embodiment, the computer-readable medium further comprises code for receiving a query by a user at the at least one medical information system 104 regarding the type of drug and dosage level to be administered to the patient and code for sending the query to the central server system 102.

A technical effect of the executable instructions is to facilitate automatic decision-making thereby facilitating and/or assisting a user in automatic patient diagnosis, drug prescription and drug delivery.

Various advantages of the automatic drug prescription system and method described herein are understood by those skilled in the art. An example includes, the central server system 102 of the invention utilizes patient data to a greater extent as a parameter to be used for automatic patient diagnosis, drug prescription and drug delivery. The invention conducts analysis of the patient data to provide a clearer picture of patient condition and for subsequent recommendation of drug prescription.

In one exemplary embodiment, the invention can be used in prescribing drugs for a patient having renal dysfunction.

In various embodiments of the invention, an automatic prescription device for a medical facility is described. However, the embodiments are not limited and may be implemented in connection with different applications. The application of the invention can be extended to other areas, for example automatic decision-making modules. The design can be carried further and implemented in various forms and specifications.

This written description uses examples to describe the subject matter herein, including the best mode, and also to enable any person skilled in the art to make and use the subject matter. The patentable scope of the subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method of automatic drug prescription, the method comprising:
receiving a query at a central server system regarding a patient, the query concerning the type of drug and dosage level to be administered to the patient;
obtaining patient data from at least one medical information system coupled to the central server system; and
processing the patient data to determine a set of drug and dosage level that can be administered to the patient.

2. The method of claim 1, wherein the query comprises a patient identification data.

3. The method of claim 2, wherein the patient identification data comprises at least one of a patient name and a patient identification number.

4. The method of claim 1, wherein obtaining patient data comprises:
querying the at least one medical information system for patient data concerning the patient; and
receiving the patient data from the at least one medical information system.

5. The method of claim 1, further comprising:
receiving a query by a user at the at least one medical information system regarding the type of drug and dosage level to be administered to the patient; and
sending the query to the central server system.

6. The method of claim 1 further comprising:
coupling a drug source unit to the central server system; and
configuring the drug source unit to deliver the set of drug and dosage level to the patient as determined by the central server system.

7. The method of claim 1, further comprising producing a diagnosis of the patient based upon the patient data.

8. The method of claim 1, further comprising communicating to a user the type of drug and dosage level recommended for the patient, as determined by the central server system.

9. An automatic drug prescription device comprising:
a central server system configured to receive a query regarding the type of drug and dosage level to be administered to a patient;
at least one medical information system coupled to the central server system and configured to provide patient data concerning the patient; and
wherein the central server system is configured to obtain the patient data from the at least one medical information system and process the patient data to determine a set of drug and dosage level that can be administered to the patient.

10. The automatic drug prescription device of claim 9, wherein the query comprises a patient identification data.

11. The automatic drug prescription device of claim 10, wherein the patient identification data is at least one of a patient name and a patient identification number.

12. The automatic drug prescription device of claim 9, wherein the medical information system is one of a laboratory information system (LIS), a clinical information system (CIS), a radiology information system (RIS), a picture archival and communication system (PACS), a gas analyzer, anesthetic device, urine output analyzer, a pulse oximeter, a capnometer, a blood pressure monitor, an EKG, an FEG, a patient monitor, a drug database unit and a renal blood flow monitor.

13. The automatic drug prescription device of claim 9, further comprising a display device for communicating to a user the type of drug and dosage level recommended for the patient, as determined by the central server system.

14. The automatic drug prescription device of claim 9, further comprising a drug source unit coupled to the central server system, the drug source unit configured to deliver the set of drug and dosage level to the patient as determined by the central server system.

15. The automatic drug prescription device of claim 9, wherein the central server system is further configured to produce a diagnosis of patient condition based upon the patient data.

16. A computer-readable medium having computer-executable instructions for automatic drug prescription, the computer-executable instructions comprising:
code for receiving a query at a central server system regarding a patient, the query concerning the type of drug and dosage level to be administered to the patient;
code for obtaining patient data from at least one medical information system coupled to the central server system; and
code for processing the patient data to determine a set of drug and dosage level that can be administered to the patient.

17. The computer-readable medium of claim 16, wherein the code for obtaining patient data comprises:
code for querying the at least one medical information system for the patient data concerning the patient; and
code for receiving the patient data from the at least one medical information system.

18. The computer-readable medium of claim 16, further comprising:
code for receiving a query by a user at the at least one medical information system regarding the type of drug and dosage level to be administered to the patient; and
code for sending the query to the central server system.

19. The computer-readable medium of claim 16, further comprising:
code for coupling a drug source unit to the central server system; and
code for configuring the drug source unit to deliver the set of drug and dosage level to the patient as determined by the central server system.

20. The computer-readable medium of claim 16, further comprising code for producing a diagnosis of the patient based upon the patient data.

21. The computer-readable medium of claim 16, further comprising code for communicating to a user the type of drug and dosage level recommended for the patient, as determined by the central server system.
